(19) United States
(12) Patent Application Publication
(10) Pub. No.: US 2025/0203574 A1
(43) Pub. Date: Jun. 19, 2025

(54) PAGING MESSAGE PROCESSING METHOD AND APPARATUS, COMMUNICATIONS DEVICE, AND READABLE STORAGE MEDIUM

(71) Applicant: VIVO MOBILE COMMUNICATION CO., LTD., Guangdong (CN)

(72) Inventors: Qian ZHENG, Guangdong (CN); Xiaodong YANG, Guangdong (CN)

(73) Assignee: VIVO MOBILE COMMUNICATION CO., LTD., Guangdong (CN)

(21) Appl. No.: 19/064,091

(22) Filed: Feb. 26, 2025

Related U.S. Application Data
(63) Continuation of application No. PCT/CN2023/113949, filed on Aug. 21, 2023.

(30) Foreign Application Priority Data
Aug. 26, 2022 (CN) 202211035819.2

(51) Int. Cl. H04W 68/00; H04L 9/32; H04W 12/037

(52) U.S. Cl. CPC H04W 68/00; H04L 9/3247; H04W 12/037

(57) ABSTRACT

A paging message processing method and apparatus, a communications device, and a readable storage medium. The method includes: sending, by a terminal, capability information related to security protection of a paging message; and receiving, by the terminal, configuration information, where the configuration information is used to enable or disable security protection for the paging message.

### CROSS-REFERENCE TO RELATED APPLICATIONS

This application is a continuation of International Application No. PCT/CN2023/113949 filed on Aug. 21, 2023, which claims priority to Chinese Patent Application No. 202211035819.2 filed on Aug. 26, 2022, which are incorporated herein by reference in their entireties.

### TECHNICAL FIELD

This application pertains to the field of communications technologies, and specifically relates to a paging message processing method and apparatus, a communications device, and a readable storage medium.

### BACKGROUND

In the related technology, a base station sends a paging message to a terminal (for example, a user equipment (UE)) through broadcast. Content of the paging message is sent in plaintext. If an unauthorized base station sends a paging message to indicate a terminal camping on the unauthorized base station to perform some operations (for example, falling back a fifth-generation mobile communications technology (5G) network to a fourth-generation mobile communications technology (4G) network based on an evolved packet system (EPS) fallback indicator), the terminal works based on an indication of the unauthorized base station. This leads to failure of related policies configured by an operator, and may even induce the UE to access the unauthorized base station, causing unpredictable losses to a user. Therefore, security of a paging process in the related technology is relatively low.

### SUMMARY

According to a first aspect, a paging message processing method is provided, including:
sending, by a terminal, capability information related to security protection of a paging message; and
receiving, by the terminal, configuration information, where the configuration information is used to enable or disable security protection for the paging message.

According to a second aspect, a paging message processing method is provided, including:
receiving, by a network-side device, capability information that is of a terminal and that is related to security protection of a paging message; and
sending, by the network-side device, configuration information to the terminal, where the configuration information is used to enable or disable security protection for the paging message.

According to a third aspect, a paging message processing method is provided, including:
determining, by a third base station, that a paging record in a paging message includes a digital signature corresponding to the paging message; and
sending, by the third base station, the paging message; or
determining, by a third base station, whether to enable security protection for a paging message;
determining, by the third base station, content of the paging message based on a case that security protection is enabled or disabled; and
sending, by the third base station, the paging message.

According to a fourth aspect, a paging message processing apparatus is provided, including:
a first sending module, configured to send capability information related to security protection of a paging message; and
a first receiving module, configured to receive configuration information, where the configuration information is used to enable or disable security protection for the paging message.

According to a fifth aspect, a paging message apparatus is provided, including:
a third receiving module, configured to receive capability information that is of a terminal and that is related to security protection of a paging message; and
a third sending module, configured to send configuration information to the terminal, where the configuration information is used to enable or disable security protection for the paging message.

According to a sixth aspect, a paging message processing apparatus is provided, including:
a fourth determining module, configured to determine that a paging record in a paging message includes a digital signature corresponding to the paging message; and
a tenth sending module, configured to send the paging message; or
a second determining module, configured to determine whether to enable security protection for a paging message;
a fifth determining module, configured to determine content of the paging message based on a case that security protection is enabled or disabled; and
an eleventh sending module, configured to send the paging message.

According to a seventh aspect, a communications device is provided, including a processor and a memory, where the memory stores a program or instructions capable of running on the processor, and the program or instructions are executed by the processor to implement the steps of the method according to the first aspect, the second aspect, or the third aspect.

According to an eighth aspect, a readable storage medium is provided, where the readable storage medium stores a program or instructions, and the program or the instructions are executed by a processor to implement the steps of the method according to the first aspect, the second aspect, or the third aspect.

According to a ninth aspect, a chip is provided, where the chip includes a processor and a communications interface, the communications interface is coupled to the processor, the processor is configured to run a program or instructions to implement the steps of the method according to the first aspect, the second aspect, or the third aspect.

According to a tenth aspect, a computer program/program product is provided, where the computer program/program product is stored in a non-transitory storage medium, and the program/program product is executed by at least one processor to implement the steps of the method according to the first aspect, the second aspect, or the third aspect.

According to an eleventh aspect, a communications system is provided, where the communications system includes a terminal and a network-side device, the terminal is configured to perform the steps of the method according to the first aspect, and the network-side device is configured to perform the steps of the method according to the second aspect or the third aspect.

### BRIEF DESCRIPTION OF DRAWINGS

FIG. 1 is a schematic diagram of verifying system information by using a digital signature;

FIG. 2 is a schematic diagram of an architecture of a wireless communications system according to an embodiment of this application;

FIG. 3 is a first flowchart of a paging message processing method according to an embodiment of this application;

FIG. 4 is a second flowchart of a paging message processing method according to an embodiment of this application;

FIG. 5 is a third flowchart of a paging message processing method according to an embodiment of this application;

FIG. 6 is a first schematic diagram of a paging message processing apparatus according to an embodiment of this application;

FIG. 7 is a second schematic diagram of a paging message processing apparatus according to an embodiment of this application;

FIG. 8 is a third schematic diagram of a paging message processing apparatus according to an embodiment of this application;

FIG. 9 is a schematic diagram of a terminal according to an embodiment of this application;

FIG. 10 is a schematic diagram of a network-side device according to an embodiment of this application; and

FIG. 11 is a schematic diagram of a communications device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

Terms “first”, “second”, and the like in the specification and claims of this application are used to distinguish between similar objects without having to describe a specific order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a long term evolution (LTE)/LTE-advanced (LTE-A) system, and may be further applied to other wireless communications systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. The following describes a new radio (NR) system for illustrative purposes, and NR terms are used in most of the following descriptions. However, these technologies may also be applicable to applications such as a 6th generation (6G) communications system other than NR system applications.

To facilitate understanding of the implementations of this application, the following technical points are first described below.

### I. System Information Signing

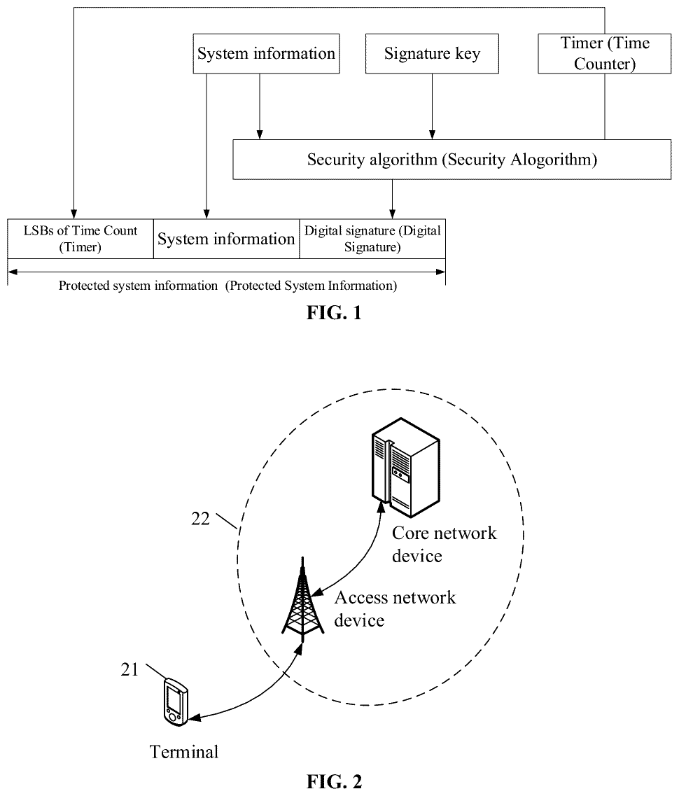

As shown in FIG. 1, the following input parameters are used to verify system information: system information (SI), a signature key, information related to a sending time of the SI, and the like. An output result is a digital signature (DS) corresponding to the SI.

The related technology discloses a method for digitally signing the system information. However, there is no encryption requirement for the system information, and integrity protection is mainly performed. Therefore, a mechanism for whether to encrypt a paging message and/or perform integrity protection on the paging message and how to encrypt a paging message and/or perform integrity protection on the paging message is unclear.

### II. Paging Message

A network pages one or more UEs by using the paging message. One paging message includes at least one paging record, and each paging record corresponds to paging of one UE, and may carry the following information:
a terminal identifier (UE Identifier, UE ID), for example, a 5G S-temporary mobile subscription identifier (5G-S-TMSI) and an inactive radio network temporary identifier (I-RNTI);
a paging cause, for example, voice; and
an access type, for example, a 3rd Generation Partnership Project (3GPP) access manner and a non-3GPP access manner.

FIG. 2 is a block diagram of a wireless communications system applicable to an embodiment of this application. The wireless communications system includes a terminal 21 and a network-side device 22.

The terminal 21 may be a mobile phone, a tablet personal computer, a laptop computer or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communications function, such as a refrigerator, a television, a laundry machine, or a furniture), a gaming console, a personal computer (PC), a teller machine, a self-service machine, or another terminal-side device. The wearable device includes: a smart watch, a smart band, a smart headset, smart glasses, smart jewelry (a smart bracelet, a smart chain bracelet, a smart ring, a smart necklace, a smart anklet, a smart chain anklet, and the like), a smart wrist strap, smart clothing, and the like. In addition to the foregoing terminal device, the terminal in this application may also be a chip in the terminal, such as a modem chip or a system on chip (SoC). It should be noted that a specific type of the terminal 21 is not limited in this embodiment of this application.

The network-side device 22 may include an access network device or a core network device. The access network device may also be referred to as a radio access network device, a radio access network (RAN), a radio access network function, or a radio access network unit. The access network device 12 may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application service discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in the NR system is used as an example for description, and a specific type of the core network device is not limited.

With reference to the accompanying drawings, a paging message processing method and apparatus, a communications device, and a readable storage medium that are provided in the embodiments of this application are described in detail by using some embodiments and application scenarios thereof.

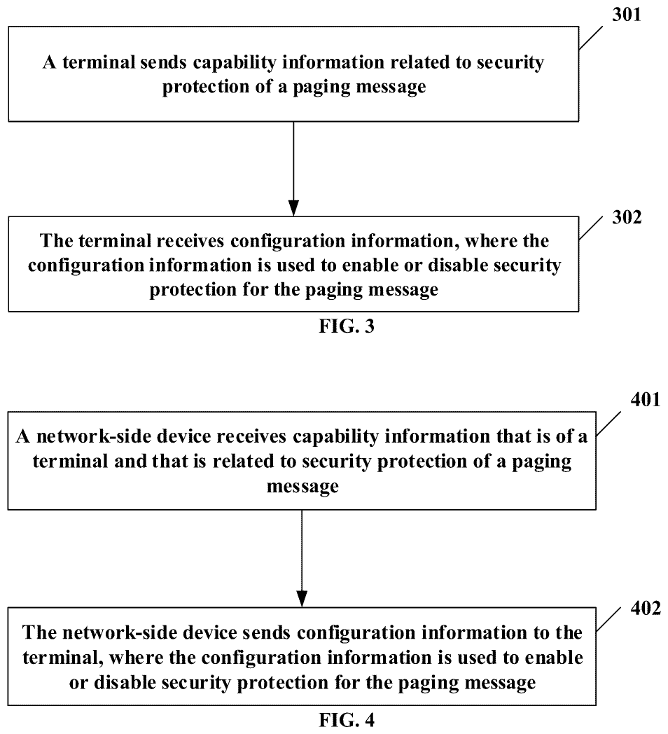

Referring to FIG. 3, an embodiment of this application provides a paging message processing method. The method is applied to a terminal. The method includes step 301 and step 302.

Step 301: A terminal sends capability information related to security protection of a paging message.

For example, the terminal sends the capability information to a core network device or a serving base station. The core network device includes but is not limited to an AMF.

Step 302: The terminal receives configuration information, where the configuration information is used to enable or disable security protection for the paging message.

For example, the terminal may receive the configuration information from the core network device or the serving base station. The core network device or the serving base station may separately send corresponding configuration information to each terminal based on capability information reported by the terminal, so that security protection at a per-terminal (per UE) level can be implemented.

Optionally, security protection includes encryption and/or digital signing.

In this embodiment, security protection is performed on the paging message through negotiation between the terminal and the network-side device by using step 301 and step 302, thereby effectively improving paging security.

In an implementation of this application, the method further includes the following:

The terminal sends an acknowledgement message in response to the configuration information.

In an implementation of this application, the capability information includes at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, the configuration information includes enabling the encryption function for the paging message, and the configuration information further includes at least one of the following:
(1) a first algorithm for encrypting the paging message, where the capability information includes the first algorithm; and
(2) a first input parameter for encrypting the paging message.

In an implementation of this application, the first input parameter includes partial information carried in a paging record of the terminal, for example, the information may be any combination of a paging Cause and an access Type. With the first input parameter, security protection may be implemented on partial content specified in the paging message.

In an implementation of this application, the configuration information includes enabling the digital signature function for the paging message, and the configuration information further includes at least one of the following:
(1) a second algorithm for digitally signing the paging message, where the capability information includes the second algorithm; and
(2) a second input parameter for digitally signing the paging message.

In an implementation of this application, the second input parameter includes any one of the following:
(1) the complete paging message;
(2) a paging record that is of the terminal and that is included in the paging message; and
(3) partial information carried in the paging record of the terminal, for example, the information may be any combination of a UE ID, a paging Cause, and an access Type.

In an implementation of this application, the method further includes the following:

The terminal receives the paging message; and
the terminal determines content of the paging message based on the capability information of the terminal and/or the configuration information.

In this embodiment, the terminal may determine the content of the paging message by using the capability information of the terminal and/or the configuration information, to verify validity of the base station.

In an implementation of this application, that the terminal determines content of the paging message based on the capability information of the terminal and/or the configuration information includes the following:

In a case that the configuration information includes enabling the encryption function for the paging message, the terminal determines that a paging record in the paging message includes at least one of the following: (1) a plaintext part of the paging record and (2) an encrypted part of the paging record.

In an implementation of this application, that the terminal determines content of the paging message based on the capability information of the terminal and/or the configuration information includes any one of the following:
(1) In a case that the configuration information includes enabling the digital signature function for the paging message, the terminal determines that a paging record in the paging message includes a digital signature corresponding to a paging record of the terminal;
(2) in a case that the configuration information includes enabling the digital signature function for the paging message, the terminal determines that the paging message includes a digital signature corresponding to the paging message; and
(3) in a case that the capability information of the terminal includes supporting the digital signature capability for the paging message, the terminal determines that the paging message includes the digital signature corresponding to the paging message.

In an implementation of this application, the digital signature corresponding to the paging record of the terminal is determined based on the encrypted paging record, or the digital signature corresponding to the paging message is determined based on the encrypted paging message.

In this embodiment of this application, security protection is performed on paging information, thereby reducing adverse impact of an unauthorized base station on the terminal, and improving paging security.

Referring to FIG. 4, an embodiment of this application provides a paging message method. The method is applied to a network-side device. Optionally, the network-side device includes a core network device or a first base station, the first base station includes a serving base station of a terminal, and the method includes step 401 and step 402.

Step 401: A network-side device receives capability information that is of a terminal and that is related to security protection of a paging message.

Step 402: The network-side device sends configuration information to the terminal, where the configuration information is used to enable or disable security protection for the paging message.

In an implementation of this application, the method further includes the following:

The network-side device receives an acknowledgement message sent by the terminal in response to the configuration information.

In an implementation of this application, the network-side device includes a core network device, and the method further includes the following:

The network-side device sends the configuration information to a first base station and/or at least one second base station.

The first base station includes a serving base station of the terminal, and the at least one second base station includes a base station to which a radio access network notification area (RNA) configuration or a tracking area (TA) configuration of the terminal belongs.

In an implementation of this application, that the network-side device sends the configuration information to a first base station and/or at least one second base station includes the following:

When the network-side device successfully receives the acknowledgement message, or when the network-side device pages the terminal, the network-side device sends the configuration information to the first base station and/or the at least one second base station.

In an implementation of this application, the method further includes the following:

When the network-side device fails to receive the acknowledgement message sent by the terminal in response to the configuration information, or when the network-side device pages the terminal, the network-side device sends indication information to the first base station and/or the at least one second base station, where the indication information is used to indicate not to enable security protection for the paging message of the terminal.

In an implementation of this application, the network-side device includes a first base station, the first base station includes a serving base station of the terminal, and the method further includes the following:

The network-side device sends the configuration information to at least one second base station, where the at least one second base station includes a base station to which a radio access network notification area RNA configuration or a tracking area TA configuration of the terminal belongs.

In an implementation of this application, that the network-side device sends the configuration information to at least one second base station includes the following:

When the network-side device successfully receives the acknowledgement message sent by the terminal in response to the configuration information, or when the network-side device pages the terminal, the network-side device sends the configuration information to the at least one second base station.

In an implementation of this application, the method further includes the following:

When the network-side device fails to receive the acknowledgement message sent by the terminal in response to the configuration information, or when the network-side device pages the terminal, the network-side device sends indication information to the at least one second base station, where the indication information is used to indicate not to enable security protection for the paging message of the terminal.

In an implementation of this application, the network-side device is a first base station, the first base station includes a serving base station of the terminal, and before the network-side device sends the configuration information to the terminal, the method further includes the following:

The network-side device sends the capability information to a core network device; and
the network-side device receives the configuration information sent by the core network device.

In an implementation of this application, the network-side device is a first base station, and the method further includes the following:

The network-side device determines whether to enable security protection for the paging message of the terminal;
the network-side device determines content of the paging message based on a case that security protection is enabled or disabled; and
the network-side device sends the paging message.

In an implementation of this application, that the network-side device determines whether to enable security protection for the paging message includes at least one of the following:

The network-side device sequentially determines, based on a sending sequence of paging records in the paging message, whether to enable security protection for the paging message; and
the network-side device determines, based on the configuration information, whether to enable security protection for the paging message.

In an implementation of this application, that the network-side device determines content of the paging message based on a case that security protection is enabled includes the following:

The network-side device determines, in a case that an encryption function is enabled, that a paging record in the paging message includes at least one of the following:
(1) a plaintext part of the paging record; and
(2) an encrypted part of the paging record.

In an implementation of this application, that the network-side device determines, based on a case that security protection is enabled, that a paging record in the paging message includes an encrypted part of the paging record includes at least one of the following:

The network-side device receives the encrypted part that is of the paging record and that is sent by a core network device; and
the network-side device performs an encryption operation on the paging record to obtain the encrypted part of the paging record.

In an implementation of this application, that the network-side device determines content of the paging message based on a case that security protection is enabled includes any one of the following:
(1) In a case that a digital signature function is enabled, the network-side device determines that a paging record in the paging message includes a digital signature corresponding to a paging record of the terminal; and
(2) in a case that the digital signature function is enabled, the network-side device determines that the paging message includes a digital signature corresponding to the paging message.

In an implementation of this application, the digital signature corresponding to the paging record of the terminal is determined based on the encrypted paging record.

In an implementation of this application, the method further includes the following:

The network-side device determines that the paging message includes a digital signature corresponding to the paging message; and
the network-side device sends the paging message.

In an implementation of this application, the digital signature corresponding to the paging message is determined based on the encrypted paging message.

In an implementation of this application, the capability information includes at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, the configuration information includes enabling the encryption function for the paging message, and the configuration information further includes at least one of the following:
(1) information about a first algorithm for encrypting the paging message, where the capability information of the terminal includes the first algorithm; and
(2) a first input parameter for encrypting the paging message.

In an implementation of this application, the configuration information includes enabling the digital signature function for the paging message, and the configuration information further includes at least one of the following:
(1) a second algorithm for digitally signing the paging message, where the capability information of the terminal includes the second algorithm; and
(2) a second input parameter for digitally signing the paging message.

In an implementation of this application, the first input parameter includes:
partial information carried in a paging record of the terminal.

In an implementation of this application, the second input parameter includes any one of the following:
(1) the complete paging message;
(2) a paging record that is of the terminal and that is included in the paging message; and
(3) partial information carried in the paging record of the terminal.

In the embodiments of this application, security protection is performed on the paging message through negotiation between the terminal and the network-side device, thereby reducing adverse impact of an unauthorized base station on the terminal, and improving paging security.

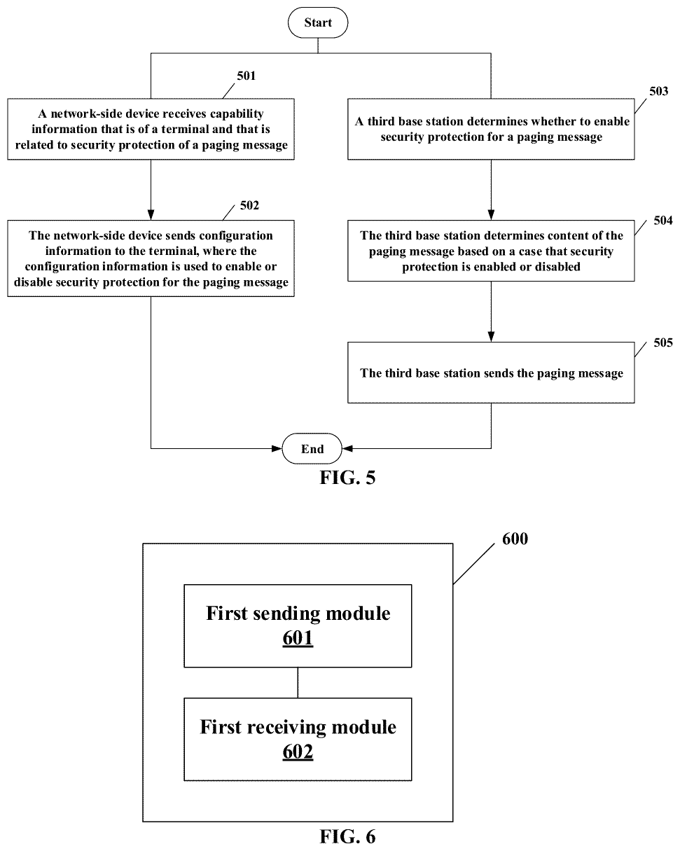

Referring to FIG. 5, an embodiment of this application provides a paging message processing method. The method is applied to a third base station. The third base station includes a first base station or a second base station, the first base station includes a serving base station of the terminal, and the second base station includes a base station to which an RNA configuration or TA configuration of the terminal belongs. Specific steps include step 501 and step 502, or step 503, step 504, and step 505.

Step 501: A third base station determines that a paging record in a paging message includes a digital signature corresponding to the paging message.

Step 502: The third base station sends the paging message.

Alternatively,

Step 503: A third base station determines whether to enable security protection for a paging message.

Step 504: The third base station determines content of the paging message based on a case that security protection is enabled or disabled.

Step 505: The third base station sends the paging message.

It may be understood that, when determining the content of the paging message, the third base station may determine the content of the paging message based on configuration information.

In an implementation of this application, that a third base station determines whether to enable security protection for a paging message includes at least one of the following:

The third base station sequentially determines, based on a sending sequence of paging records in the paging message, whether to enable security protection for the paging message; and
the network-side device determines, based on configuration information, whether to enable security protection for the paging message.

In an implementation of this application, that the third base station determines content of the paging message based on a case that security protection is enabled includes the following:

The third base station determines, in a case that an encryption function is enabled, that a paging record in the paging message includes at least one of the following:
(1) a plaintext part of the paging record; and
(2) an encrypted part of the paging record.

In an implementation of this application, the third base station includes a first base station, the first base station includes a serving base station of the terminal, and that the third base station determines that a paging record in the paging message includes an encrypted part of the paging record includes at least one of the following:

The third base station receives the encrypted part that is of the paging record and that is sent by a core network device, where an encryption operation on the encrypted part of the paging record is performed by the core network device; and
the third base station performs the encryption operation on the paging record to obtain the encrypted part of the paging record.

In an implementation of this application, the third base station includes a second base station, the second base station includes a base station to which an RNA configuration or a TA configuration of the terminal belongs, and that the third base station determines that a paging record in the paging message includes an encrypted part of the paging record includes the following:

The third base station receives the encrypted part that is of the paging record and that is sent by an anchor base station of the terminal, where an encryption operation on the encrypted part of the paging record is performed by the anchor base station.

The anchor base station of the terminal includes a first base station.

In an implementation of this application, that the third base station determines, in a case that security protection is enabled, content of the paging message based on a case that security protection is enabled includes any one of the following:

In a case that a digital signature function is enabled, the third base station determines that a paging record in the paging message includes a digital signature corresponding to a paging record of the terminal; and
in a case that the digital signature function is enabled, the third base station determines that the paging message includes a digital signature corresponding to the paging message.

In an implementation of this application, the digital signature corresponding to the paging record of the terminal is determined based on the encrypted paging record.

In an implementation of this application, the digital signature corresponding to the paging message is determined based on the encrypted paging message.

In an implementation of this application, before a third base station determines whether to enable security protection for a paging message of a terminal, the method further includes the following:

The third base station receives configuration information, where the configuration information is used to enable or disable security protection for the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, in a case that the configuration information includes enabling the encryption function for the paging message, the configuration information further includes at least one of the following:
(1) a first algorithm for encrypting the paging message, where the capability information of the terminal includes the first algorithm; and
(2) a first input parameter for encrypting the paging message.

In an implementation of this application, in a case that the configuration information includes enabling the digital signature function for the paging message, the configuration information further includes at least one of the following:
(1) a second algorithm for digitally signing the paging message, where the capability information of the terminal includes the second algorithm; and
(2) a second input parameter for digitally signing the paging message.

In an implementation of this application, the first input parameter includes: partial information carried in a paging record of the terminal.

In an implementation of this application, the second input parameter includes any one of the following:
(1) the complete paging message;
(2) a paging record that is of the terminal and that is included in the paging message; and
(3) partial information carried in the paging record of the terminal.

In this embodiment, the third base station may send, to the terminal, the paging message including the digital signature or the paging message determined based on a case that security protection is enabled or disabled, so that the terminal can determine the content of the paging message by using the capability information of the terminal and/or configuration information, to verify validity of the base station, thereby reducing adverse impact of an unauthorized base station on the terminal, and improving paging security.

Embodiment 1: A negotiation procedure between a network-side device and a UE for whether and how to perform security protection on a paging message.

Example 1: The network-side device is a core network device (for example, an AMF) that serves the UE, and negotiation for security protection is implemented based on a non-access stratum (NAS) procedure. Example 1 is applicable to core network (CN) paging in a radio resource control (RRC) idle state and radio access network (RAN) paging in an inactive state.

Step 1: The UE sends, to the core network device, capability information for performing security protection on a paging message, where the capability information may include at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

Step 2: The core network device sends, to the UE, configuration information for performing security protection on the paging message, where the configuration information may be used to perform at least one of the following operations:
(1) enabling an encryption function for the paging message;
(2) disabling the encryption function for the paging message;
(3) enabling a digital signature function for the paging message; and
(4) disabling the digital signature function for the paging message.

Optionally, step 2-1: In a case that the configuration information includes enabling the encryption function for the paging message, the configuration information may further include at least one of the following:
(1) a first algorithm for encrypting the paging message, where the capability information of the terminal includes the first algorithm; and
(2) a first input parameter for encrypting the paging message, where optionally, the first input parameter includes any information other than a UE ID carried in the paging message, for example, the information may be any combination of a paging Cause and an access Type.

Optionally, step 2-2: In a case that the configuration information includes enabling the digital signature function for the paging message, the configuration information may further include at least one of the following:
(1) a second algorithm for digitally signing the paging message, where the capability information of the terminal includes the second algorithm; and
(2) a second input parameter for digitally signing the paging message.

The second input parameter may include any one of the following:
(a) the complete paging message, where the paging message includes at least a Paging Record of the UE (namely, a signature of the entire Paging message);
(b) the Paging Record that is of the UE and that is included in the paging message (namely, a signature of each UE or each Paging Record); and
(c) partial information carried in the Paging Record of the UE (namely, further simplification of the signature of each UE or each Paging Record), for example, the information may be any combination of a UE ID, a paging Cause, and an access Type.

Step 3: The UE sends, to the core network device, an acknowledgement message of the configuration information for performing security protection on the paging message.

Optionally, step 3-1: In a case that the core network device successfully receives the acknowledgement message of the UE, the core network device forwards the configuration information to a first base station and at least one second base station, so that the at least one second base station enables security protection for the paging message of the UE based on the configuration information.

The first base station is a serving base station.

Optionally, the at least one second base station may be a base station to which a TA configuration of the UE belongs (for CN Paging in an RRC idle state) or a base station to which an RNA configuration of the UE belongs (for RAN Paging in an RRC inactive state).

Optionally, when successfully receiving the acknowledgement message or at a moment of Paging the terminal, the core network device may forward the configuration information to the at least one second base station.

Optionally, step 3-2: In a case that the core network device fails to receive the acknowledgement message of the UE, the core network device determines that the configuration information fails. Further, the core network device may send indication information to at least one second base station, where the indication information is used to indicate not to enable security protection for the paging message of the UE, so that the at least one second base station does not enable security protection for the paging message of the UE.

Optionally, the at least one second base station is a base station to which an RNA configuration of the UE belongs (for CN Paging in an RRC idle state) or a base station to which a TA configuration of the UE belongs (for RAN Paging in an RRC INACTIVE state).

Optionally, the core network device may send the indication information to at least one base station at a Paging moment.

Example 2: The network-side device is a first base station (namely, a first base station) that serves the UE, and negotiation for security protection is implemented based on an RRC procedure.

Step 1: The UE sends, to the first base station, capability information for performing security protection on a paging message, where the capability information may include at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

Optionally, after step 1, before step 2 is performed, the first base station forwards the capability information of the UE to a core network device, and receives, from the core network device, configuration information for performing security protection on the paging message.

Step 2: The first base station sends, to the UE, configuration information for performing security protection on the paging message, where the configuration information may be used to perform at least one of the following operations:
(1) enabling an encryption function for the paging message;
(2) disabling the encryption function for the paging message;
(3) enabling a digital signature function for the paging message; and
(4) disabling the digital signature function for the paging message.

Optionally, step 2-1: In a case that the configuration information includes enabling the encryption function for the paging message, the configuration information may further include at least one of the following:
(1) a first algorithm for encrypting the paging message, where the capability information of the terminal includes the first algorithm; and
(2) a first input parameter for encrypting the paging message, where optionally, the first input parameter includes any information other than a UE ID carried in the paging message, for example, the information may be any combination of a paging Cause and an access Type.

Optionally, step 2-2: In a case that the configuration information includes enabling the digital signature function for the paging message, the configuration information may further include at least one of the following:
(1) a second algorithm for digitally signing the paging message, where the capability information of the terminal includes the second algorithm; and
(2) a second input parameter for digitally signing the paging message.

The second input parameter may include any one of the following:
(a) the complete paging message, where the paging message includes at least a Paging Record of the UE (namely, a signature of the entire Paging message);
(b) the Paging Record that is of the UE and that is included in the paging message (namely, a signature of each UE or each Paging Record); and
(c) partial information carried in the Paging Record of the UE (namely, further simplification of the signature of each UE or each Paging Record), for example, the information may be any combination of a UE ID, a paging Cause, and an access Type.

Step 3: The UE sends, to the first base station, an acknowledgement message of the configuration information for performing security protection on the paging message.

Optionally, step 3-1: In a case that the first base station successfully receives the acknowledgement message of the UE, the first base station forwards the configuration information to at least one second base station, so that the at least one second base station enables security protection for the paging message of the UE based on the configuration information.

Optionally, the at least one second base station is a base station to which an RNA configuration of the UE belongs (for RAN Paging in an RRC inactive state).

Optionally, when successfully receiving the acknowledgement message of the UE or at a moment of Paging the terminal, for example, when initiating RAN Paging on the UE, the first base station may forward the configuration information to the at least one second base station.

Optionally, step 3-2: In a case that the first base station fails to receive the acknowledgement message of the UE, the first base station determines that the configuration information fails. Further, the first base station may send indication information to at least one second base station, where the indication information is used to indicate not to enable security protection for the paging message of the UE, so that the at least one second base station does not enable security protection for the paging message of the UE.

Optionally, the at least one second base station is a base station to which an RNA configuration of the UE belongs (for RAN Paging in an RRC INACTIVE state).

Optionally, the first base station may send the indication information to at least one base station at a Paging moment.

Embodiment 2: Content and a sending manner of a Paging message.

Step 1: A third base station sequentially determines, based on a sending sequence of PagingRecords in a paging message, whether security protection is enabled for a paging message of each UE, and determines specific content of the paging message.

The third base station may include a first base station or a second base station. The first base station includes a serving base station of the terminal, and the second base station includes a base station to which an RNA configuration or a TA configuration of the terminal belongs.

Optionally, step 1-1: In a case that the encryption function is enabled for the paging message of the UE, a PagingRecord of the UE includes at least one of the following:
(1) a plaintext part of the PagingRecord, where the plaintext part includes at least a UE ID; and
(2) an encrypted part of the PagingRecord (corresponding to step 2-1 in Embodiment 1).

Further, in a case that the PagingRecord of the UE includes the encrypted part, any one of the following is further included:

An encryption operation is performed by a core network device, and then the encrypted PagingRecord is sent to the first base station (applicable to a case that the paging message is CN paging);
the encryption operation is performed by the first base station, and the encrypted PagingRecord is directly generated, where the first base station is an anchor base station of the UE (applicable to a case that the paging message is RAN paging); and
the encryption operation is performed by the anchor base station of the UE, and the encrypted PagingRecord is directly generated and forwarded to the second base station (applicable to a case that the paging message is RAN paging).

It should be noted that a setting sequence of the plaintext part and the encrypted part is not limited in the PagingRecord. In the PagingRecord, the plaintext part may be first set, and then the encrypted part is set, that is, the plaintext part is first sent, and then the ciphertext part is sent, for example, a PagingRecord {UE ID in plaintext; ciphertext obtained through joint encryption based on paging Cause and access Type}.

In the PagingRecord, the encrypted part may be first set, and then the plaintext part is set, that is, the ciphertext part is first sent, and then the plaintext part is sent, for example, a PagingRecord {ciphertext obtained through joint encryption based on paging Cause and access Type; UE ID in plaintext}.

It should be noted that the encrypted part of the PagingRecord may be obtained through joint encryption, or the encrypted part of the PagingRecord may be obtained through separate encryption, for example:
(a) a PagingRecord {UE ID, paging Cause, and access Type all in plaintext} when the encryption function is not enabled;
(b) a PagingRecord {UE ID in plaintext; ciphertext obtained through encryption based on paging Cause, and ciphertext obtained through encryption based on access Type} during separate encryption; and
(c) a PagingRecord {UE ID in plaintext; ciphertext obtained through joint encryption based on paging Cause and access Type} during joint encryption.

Optionally, step 1-2: In a case that the digital signature function (a signature per UE) is enabled for paging of the UE, a PagingRecord of the UE includes a DS corresponding to the PagingRecord of the UE (corresponding to step 2-2 in Embodiment 1).

The DS is calculated by using the encrypted PagingRecord, that is, a transmit end needs to perform encryption before performing signature.

For example, the paging message is {PagingRecord 1, PagingRecord 2, . . . , PagingRecord N}.

The PagingRecord 1 corresponds to a UE 1, the PagingRecord 2 corresponds to a UE 2, . . . , and the PagingRecord N corresponds to a UE N.

In a case that the digital signature is enabled for a specific UE, such as the UE 1 and the UE 2, the Paging message is {{PagingRecord 1, DS1}, {PagingRecord 2, DS2}, . . . , PagingRecord N}.

Optionally, step 1-3: In a case that the digital signature function (a signature per Paging message) is enabled for paging of the UE, the Paging message includes at least one of the following: a DS corresponding to the paging message (corresponding to step 2-2 in Embodiment 1).

The DS is calculated by using the encrypted Paging message, that is, a transmit end needs to perform encryption before performing signature.

For example, the Paging message is {PagingRecord 1, PagingRecord 2, . . . , PagingRecord N}.

The PagingRecord 1 corresponds to a UE 1, the PagingRecord 2 corresponds to a UE 2, . . . , and the PagingRecord N corresponds to a UE N.

In a case that the digital signature function is enabled for paging of the UE, the Paging message is {PagingRecord 1, PagingRecord 2, . . . , PagingRecord N, DS}. That is, the UE 1, the UE 2, . . . , the UE N verifies the Paging message based on a same DS.

Step 2: Send the Paging message based on content in steps 1-1, 1-2, and 1-3.

Optionally, content related to the DS may also be separately sent in another paging message.

For example, there are two paging messages, so that paging with the DS and paging without the DS can separately sent.

The Paging message is {PagingRecord 1, PagingRecord 2, . . . , PagingRecord N}.

The PagingRecord 1 corresponds to a UE 1, the PagingRecord 2 corresponds to a UE 2, . . . , and the PagingRecord N corresponds to a UE N.

If the digital signature is enabled only for a specific UE, such as the UE 1 and the UE 2, and the digital signature is not enabled for another UE, the UE for which the digital signature is not enabled and the UE for which the digital signature is enabled separately perform sending.

A Paging message 1 is {PagingRecord 3, . . . , PagingRecord N}.

A Paging message 2 is {{PagingRecord 1, DS1}, {PagingRecord 2, DS2}}.

Referring to FIG. 6, an embodiment of this application provides a paging message processing apparatus. The apparatus is applied to a terminal. The apparatus 600 includes:
a first sending module 601, configured to send capability information related to security protection of a paging message; and
a first receiving module 602, configured to receive configuration information, where the configuration information is used to enable or disable security protection for the paging message.

In an implementation of this application, the apparatus further includes:
a second sending module, configured to send, by the terminal, an acknowledgement message in response to the configuration information.

In an implementation of this application, the capability information includes at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, the configuration information includes enabling the encryption function for the paging message, and the configuration information further includes at least one of the following:
(1) a first algorithm for encrypting the paging message, where the capability information includes the first algorithm; and
(2) a first input parameter for encrypting the paging message.

In an implementation of this application, the configuration information includes enabling the digital signature function for the paging message, and the configuration information further includes at least one of the following:
(1) a second algorithm for digitally signing the paging message, where the capability information includes the second algorithm; and
(2) a second input parameter for digitally signing the paging message.

In an implementation of this application, the first input parameter includes partial information carried in a paging record of the terminal.

In an implementation of this application, the second input parameter includes any one of the following:
(1) the complete paging message;
(2) a paging record that is of the terminal and that is included in the paging message; and
(3) partial information carried in the paging record of the terminal.

In an implementation of this application, the apparatus further includes:
a second receiving module, configured to receive the paging message; and
a first determining module, configured to determine content of the paging message based on the capability information of the terminal and/or the configuration information.

In an implementation of this application, the first determining module is further configured to:
in a case that the configuration information includes enabling the encryption function for the paging message, determine that a paging record in the paging message includes at least one of the following: (1) a plaintext part of the paging record and (2) an encrypted part of the paging record.

In an implementation of this application, the first determining module is further configured to perform any one of the following operations:
(1) in a case that the configuration information includes enabling the digital signature function for the paging message, determining that a paging record in the paging message includes a digital signature corresponding to a paging record of the terminal;
(2) in a case that the configuration information includes enabling the digital signature function for the paging message, determining that the paging message includes a digital signature corresponding to the paging message; and
(3) in a case that the capability information of the terminal includes supporting the digital signature capability for the paging message, determining that the paging message includes the digital signature corresponding to the paging message.

In an implementation of this application, the digital signature corresponding to the paging record of the terminal is determined based on the encrypted paging record, or the digital signature corresponding to the paging message is determined based on the encrypted paging message.

The apparatus provided in this embodiment of this application can implement processes implemented in the method embodiment in FIG. 3, and achieve same technical effects. To avoid repetition, details are not described herein again.

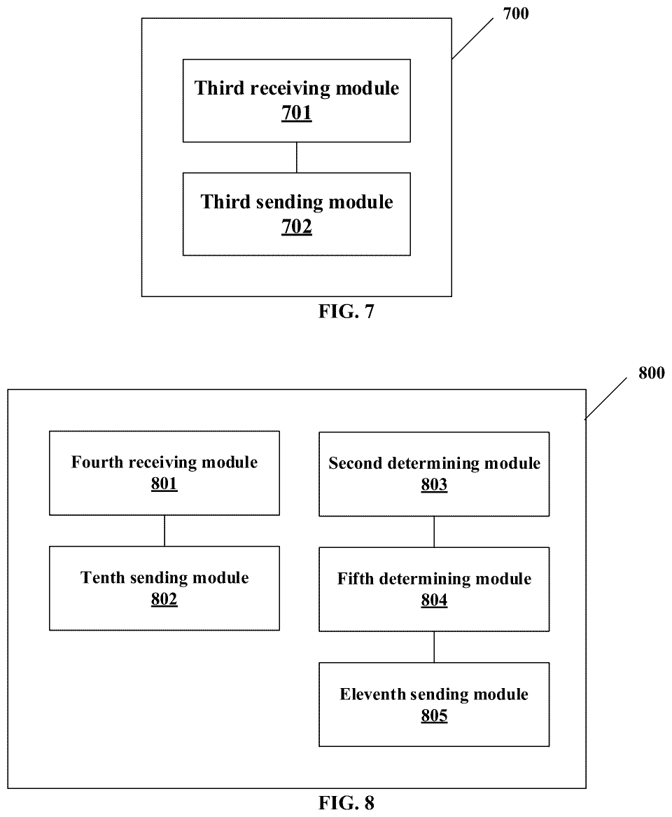

Referring to FIG. 7, an embodiment of this application provides a paging message apparatus. The apparatus is applied to a network-side device. Optionally, the network-side device includes a core network device or a first base station, the first base station includes a serving base station of the terminal, and the apparatus 700 includes:
a third receiving module 701, configured to receive capability information that is of a terminal and that is related to security protection of a paging message; and
a third sending module 702, configured to send configuration information to the terminal, where the configuration information is used to enable or disable security protection for the paging message.

In an implementation of this application, the apparatus 700 further includes:
a fourth receiving module, configured to receive an acknowledgement message sent by the terminal in response to the configuration information.

In an implementation of this application, the network-side device includes a core network device, and the apparatus 700 further includes:
a fourth sending module, configured to send the configuration information to a first base station and/or at least one second base station.

The first base station includes a serving base station of the terminal, and the at least one second base station includes a base station to which a radio access network notification area RNA configuration or a tracking area TA configuration of the terminal belongs.

In an implementation of this application, the fourth sending module is further configured to:
when the acknowledgement message is successfully received, or when the network-side device pages the terminal, send the configuration information to the at least one second base station.

In an implementation of this application, the fourth sending module is further configured to:
when the acknowledgement message sent by the terminal in response to the configuration information fails to be received, or when the network-side device pages the terminal, send indication information to the first base station and/or the at least one second base station, where the indication information is used to indicate not to enable security protection for the paging message of the terminal.

In an implementation of this application, the network-side device includes a first base station, the first base station includes a serving base station of the terminal, and the apparatus further includes:
a fifth sending module, configured to the configuration information to at least one second base station, where the at least one second base station includes a base station to which a radio access network notification area RNA configuration or a tracking area TA configuration of the terminal belongs.

In an implementation of this application, the fifth sending module is further configured to:
when the acknowledgement message sent by the terminal in response to the configuration information is successfully received, or when the network-side device pages the terminal, send the configuration information to the at least one second base station.

In an implementation of this application, the apparatus further includes:
a sixth sending module, configured to: when the acknowledgement message sent by the terminal in response to the configuration information fails to be received, or when the network-side device pages the terminal, send indication information to the at least one second base station, where the indication information is used to indicate not to enable security protection for the paging message of the terminal.

In an implementation of this application, the network-side device is a first base station, the first base station includes a serving base station of the terminal, and the apparatus further includes:
a seventh sending module, configured to send the capability information to a core network device; and
a fifth receiving module, configured to receive the configuration information sent by the core network device.

In an implementation of this application, the network-side device is the first base station, and the apparatus further includes:
a first determining module, configured to determine whether to enable security protection for the paging message of the terminal;
a second determining module, configured to determine content of the paging message based on a case that security protection is enabled or disabled; and
an eighth sending module, configured to send the paging message.

In an implementation of this application, the first determining module is further configured to perform at least one of the following operations:
sequentially determining, based on a sending sequence of paging records in the paging message, whether to enable security protection for the paging message; and determining, based on the configuration information, whether to enable security protection for the paging message.

In an implementation of this application, the second determining module is further configured to:
determine, in a case that an encryption function is enabled, that a paging record in the paging message includes at least one of the following:
(1) a plaintext part of the paging record; and
(2) an encrypted part of the paging record.

In an implementation of this application, the second determining module includes at least one of the following:
a first receiving unit, configured to receive the encrypted part that is of the paging record and that is sent by a core network device; and
a first encryption unit, configured to perform an encryption operation on the paging record to obtain the encrypted part of the paging record.

In an implementation of this application, the second determining module is further configured to perform any one of the following operations:
(1) in a case that a digital signature function is enabled, determining that a paging record in the paging message includes a digital signature corresponding to a paging record of the terminal; and
(2) in a case that the digital signature function is enabled, determining that the paging message includes a digital signature corresponding to the paging message.

In an implementation of this application, the digital signature corresponding to the paging record of the terminal is determined based on the encrypted paging record.

In an implementation of this application, the apparatus further includes:
a third determining module, configured to determine that the paging message includes a digital signature corresponding to the paging message; and
a ninth sending module, configured to send the paging message.

In an implementation of this application, the digital signature corresponding to the paging message is determined based on the encrypted paging message.

In an implementation of this application, the capability information includes at least one of the following:
(1) supporting an encryption capability for the paging message, or not supporting an encryption capability for the paging message;
(2) supporting at least one algorithm for encrypting the paging message;
(3) supporting a digital signature capability for the paging message, or not supporting a digital signature capability for the paging message; and
(4) supporting at least one algorithm for digitally signing the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, the configuration information includes enabling the encryption function for the paging message, and the configuration information further includes at least one of the following:
(1) information about a first algorithm for encrypting the paging message, where the capability information of the terminal includes the first algorithm; and
(2) a first input parameter for encrypting the paging message.

In an implementation of this application, the configuration information includes enabling the digital signature function for the paging message, and the configuration information further includes at least one of the following:
(1) a second algorithm for digitally signing the paging message, where the capability information of the terminal includes the second algorithm; and
(2) a second input parameter for digitally signing the paging message.

In an implementation of this application, the first input parameter includes:
partial information carried in a paging record of the terminal.

In an implementation of this application, the second input parameter includes any one of the following:
(1) the complete paging message;
(2) a paging record that is of the terminal and that is included in the paging message; and
(3) partial information carried in the paging record of the terminal.

The apparatus provided in this embodiment of this application can implement processes implemented in the method embodiment in FIG. 4, and achieve same technical effects. To avoid repetition, details are not described herein again.

Referring to FIG. 8, an embodiment of this application provides a paging message processing apparatus. The apparatus is applied to a third base station. The third base station includes a first base station or a second base station, the first base station includes a serving base station of the terminal, and the second base station includes a base station to which an RNA configuration or TA configuration of the terminal belongs. The apparatus includes a fourth determining module 801 and a tenth sending module 802, or a second determining module 803, a fifth determining module 804, and an eleventh sending module 805.

The fourth determining module 801 is configured to determine that a paging record in a paging message includes a digital signature corresponding to the paging message.

The tenth sending module 802 is configured to send the paging message.

Alternatively, the second determining module 803 is configured to determine whether to enable security protection for a paging message.

The fifth determining module 804 is configured to determine content of the paging message based on a case that security protection is enabled or disabled.

The eleventh sending module 805 is configured to send the paging message.

In an implementation of this application, the second determining module 803 is further configured to perform at least one of the following operations:
sequentially determining, based on a sending sequence of paging records in the paging message, whether to enable security protection for the paging message; and determining, based on configuration information, whether to enable security protection for the paging message.

In an implementation of this application, the fifth determining module 804 is further configured to:
determine, in a case that an encryption function is enabled, that a paging record in the paging message includes at least one of the following:
(1) a plaintext part of the paging record; and
(2) an encrypted part of the paging record.

In an implementation of this application, the third base station includes a first base station, the first base station includes a serving base station of the terminal, and the fifth determining module 804 includes at least one of the following:
a second receiving unit, configured to receive the encrypted part that is of the paging record and that is sent by a core network device, where an encryption operation on the encrypted part of the paging record is performed by the core network device; and
a second encryption unit, configured to the encryption operation on the paging record to obtain the encrypted part of the paging record.

In an implementation of this application, the third base station includes a second base station, the second base station includes a base station to which an RNA configuration or a TA configuration of the terminal belongs, and the fifth determining module 804 includes:
a second receiving unit, configured to receive the encrypted part that is of the paging record and that is sent by an anchor base station of the terminal, where an encryption operation on the encrypted part of the paging record is performed by the anchor base station.

The anchor base station of the terminal includes a first base station.

In an implementation of this application, the fifth determining module 804 is further configured to perform any one of the following operations:
in a case that a digital signature function is enabled, determining that a paging record in the paging message includes a digital signature corresponding to a paging record of the terminal; and
in a case that the digital signature function is enabled, determining that the paging message includes a digital signature corresponding to the paging message.

In an implementation of this application, the digital signature corresponding to the paging record of the terminal is determined based on the encrypted paging record.

In an implementation of this application, the digital signature corresponding to the paging message is determined based on the encrypted paging message.

In an implementation of this application, the apparatus further includes:
a sixth receiving module, configured to receive configuration information, where the configuration information is used to enable or disable security protection for the paging message.

In an implementation of this application, the configuration information is used to perform at least one of the following operations:
(1) enabling an encryption function for the paging message;
(2) disabling the encryption function for the paging message;
(3) enabling a digital signature function for the paging message; and
(4) disabling the digital signature function for the paging message.

In an implementation of this application, in a case that the configuration information includes enabling the encryption function for the paging message, the configuration information further includes at least one of the following:
(1) a first algorithm for encrypting the paging message, where the capability information of the terminal includes the first algorithm; and
(2) a first input parameter for encrypting the paging message.

In an implementation of this application, in a case that the configuration information includes enabling the digital signature function for the paging message, the configuration information further includes at least one of the following:
(1) a second algorithm for digitally signing the paging message, where capability information of the terminal includes the second algorithm; and
(2) a second input parameter for digitally signing the paging message.

In an implementation of this application, the first input parameter includes: partial information carried in a paging record of the terminal.

In an implementation of this application, the second input parameter includes any one of the following:
(1) the complete paging message;
(2) a paging record that is of the terminal and that is included in the paging message; and
(3) partial information carried in the paging record of the terminal.

The apparatus provided in this embodiment of this application can implement processes implemented in the method embodiment in FIG. 5, and achieve same technical effects. To avoid repetition, details are not described herein again.

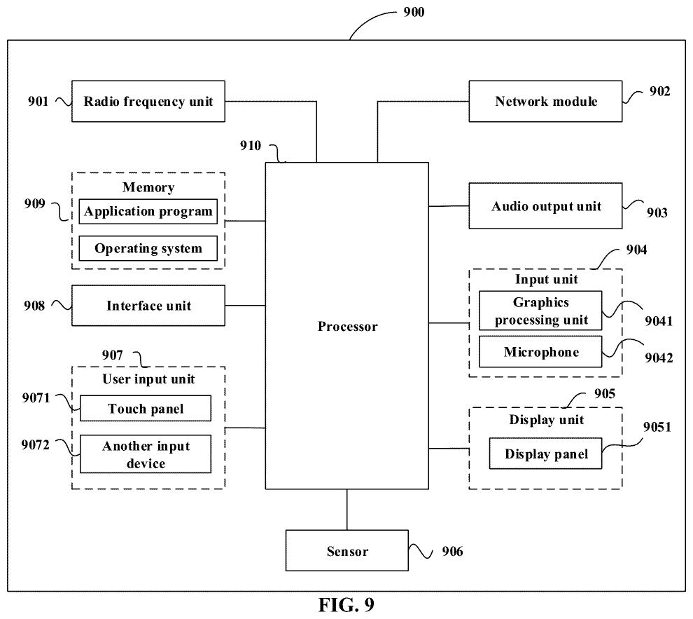

FIG. 9 is a schematic diagram of a hardware structure of a terminal according to an embodiment of this application. The terminal 900 includes but is not limited to at least some components of a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that, the terminal 900 may further include a power supply (for example, a battery) that supplies power to each component. The power supply may be logically connected to the processor 910 by using a power management system, so as to implement functions such as charging management, discharging management, and power consumption management by using the power management system. The structure of the terminal shown in FIG. 9 does not constitute a limitation on the terminal. The terminal may include more or fewer components than those shown in the figure, or combine some components, or have different component arrangements. Details are not described herein again.

It should be understood that, in this embodiment of this application, the input unit 904 may include a graphics processing unit (GPU) 9041 and a microphone 9042. The graphics processing unit 9041 processes image data of a still picture or a video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or another input device 9072. The touch panel 9071 is also referred to as a touchscreen. The touch panel 9071 may include two parts: a touch detection apparatus and a touch controller. The another input device 9072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 901 may transmit the downlink data to the processor 910 for processing. In addition, the radio frequency unit 901 may send uplink data to a network-side device. Generally, the radio frequency unit 901 includes but is not limited to an antenna, an amplifier, a transceiver, a coupler, a low-noise amplifier, a duplexer, and the like.

The memory 909 may be configured to store a software program or instructions and various types of data. The memory 909 may mainly include a first storage area for storing a program or instructions and a second storage area for storing data. The first storage area may store an operating system, an application program or instructions required by at least one function (for example, a sound play function or an image play function), and the like. In addition, the memory 909 may include a volatile memory or a non-volatile memory, or the memory 909 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 909 in this embodiment of this application includes but is not limited to these memories and any other suitable type of memory.

The processor 910 may include one or more processing units. Optionally, the processor 910 integrates an application processor and a modem processor. The application processor mainly processes operations related to an operating system, a user interface, an application program, and the like. The modem processor, such as a baseband processor, mainly processes a wireless communication signal. It may be understood that, the foregoing modem processor may not be integrated into the processor 910.

The terminal provided in this embodiment of this application can implement processes implemented in the method embodiment in FIG. 3, and achieve same technical effects. To avoid repetition, details are not described herein again.

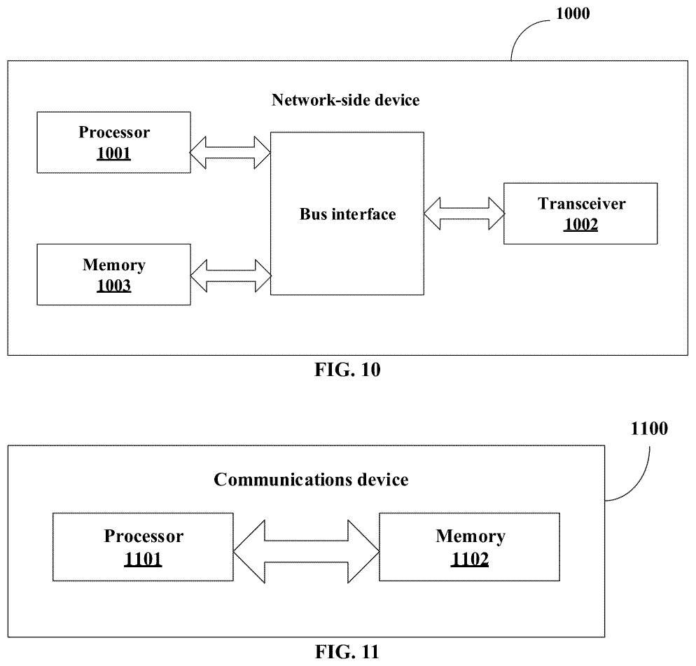

FIG. 10 is a structural diagram of a communications device applied to an embodiment of the present invention. As shown in FIG. 10, the communications device 1000 includes a processor 1001, a transceiver 1002, a memory 1003, and a bus interface. The processor 1001 may be responsible for managing a bus architecture and normal processing. The memory 1003 may store data used when the processor 1001 performs an operation.

In an embodiment of the present invention, the communications device 1000 further includes a program stored in the memory 1003 and capable of running on the processor 1001. The program is executed by the processor 1001 to implement the steps in the method shown in FIG. 4 or FIG. 5.

In FIG. 10, the bus architecture may include any quantity of interconnected buses and bridges, specifically linking various circuits of one or more processors represented by the processor 1001 and a memory represented by the memory 1003. The bus architecture may further link various other circuits such as a peripheral device, a voltage regulator, and a power management circuit together. These are all well-known in the art, and therefore are not further described in this specification. The bus interface provides an interface. The transceiver 1002 may be a plurality of elements, that is, includes a transmitter and a receiver, and provides a unit configured to communicate with various other apparatuses on a transmission medium.

Optionally, as shown in FIG. 11, an embodiment of this application further provides a communications device 1100, including a processor 1101 and a memory 1102. The memory 1102 stores a program or instructions capable of running on the processor 1101. For example, when the communications device 1100 is a terminal, the program or the instructions are executed by the processor 1101 to implement the steps in the method embodiment in FIG. 3. When the communications device 1100 is a network-side device, the program or the instructions are executed by the processor 1101 to implement the steps in the method embodiment in FIG. 4 or FIG. 5, and same technical effects can be achieved. To avoid repetition, details are not described herein again.

An embodiment of this application further provides a readable storage medium. The readable storage medium stores a program or instructions. The program or the instructions are executed by a processor to implement the method in FIG. 3, FIG. 4, or FIG. 5 and the processes in the foregoing embodiments, and same technical effects can be achieved. To avoid repetition, details are not described herein again.

The processor is a processor in the terminal in the foregoing embodiments. The readable storage medium may be non-volatile, or may be non-transitory. The readable storage medium may include a computer-readable storage medium, such as a computer read-only memory ROM, a random access memory RAM, a magnetic disk, or an optical disc.

An embodiment of this application further provides a chip. The chip includes a processor and a communications interface. The communications interface is coupled to the processor. The processor is configured to run a program or instructions to implement the processes shown in FIG. 3, FIG. 4, or FIG. 5 and in the foregoing method embodiments, and same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes shown in FIG. 3, FIG. 4, or FIG. 5 and in the foregoing method embodiments, and same technical effects can be achieved. To avoid repetition, details are not described herein again.

An embodiment of this application further provides a communications system. The communications system includes a terminal and a network-side device. The terminal is configured to execute the processes in FIG. 3 and the foregoing method embodiments. The network-side device is configured to execute the processes in FIG. 4 or FIG. 5 and the foregoing method embodiments, and same technical effects can be achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the related technologies can be embodied in a form of a computer software product. The computer software product is stored in a storage medium (such as a ROM/RAM, a magnetic disk, or an optical disc), and includes several instructions for enabling a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A paging message processing method, comprising:
sending, by a terminal, capability information related to security protection of a paging message; and
receiving, by the terminal, configuration information, wherein the configuration information is used to enable or disable security protection for the paging message.

2. The method according to claim 1, wherein the method further comprises:
sending, by the terminal, an acknowledgement message in response to the configuration information.

3. The method according to claim 1, wherein the capability information comprises at least one of the following:
supporting an encryption capability for the paging message, or not supporting an encryption capability for the paging message;
supporting at least one algorithm for encrypting the paging message;
supporting a digital signature capability for the paging message, or not supporting a digital signature capability for the paging message; or
supporting at least one algorithm for digitally signing the paging message.

4. The method according to claim 1, wherein the configuration information is used to perform at least one of operations:
enabling an encryption function for the paging message;
disabling the encryption function for the paging message;
enabling a digital signature function for the paging message; or
disabling the digital signature function for the paging message.

5. The method according to claim 4, wherein the configuration information comprises enabling the encryption function for the paging message, and the configuration information further comprises at least one of the following:
a first algorithm for encrypting the paging message, wherein the capability information comprises the first algorithm; or
a first input parameter for encrypting the paging message;
wherein the first input parameter comprises:
partial information carried in a paging record of the terminal.

6. The method according to claim 4, wherein the configuration information comprises enabling the digital signature function for the paging message, and the configuration information further comprises at least one of the following:
a second algorithm for digitally signing the paging message, wherein the capability information comprises the second algorithm; or
a second input parameter for digitally signing the paging message;
wherein the second input parameter comprises any one of the following:
the complete paging message;
a paging record that is of the terminal and that is comprised in the paging message; or
partial information carried in the paging record of the terminal.

7. The method according to claim 1, wherein the method further comprises:
receiving, by the terminal, the paging message; and
determining, by the terminal, content of the paging message based on the capability information of the terminal and/or the configuration information.

8. The method according to claim 7, wherein the determining, by the terminal, content of the paging message based on the capability information of the terminal and/or the configuration information comprises:
in a case that the configuration information comprises enabling the encryption function for the paging message, determining, by the terminal, that a paging record in the paging message comprises at least one of the following: a plaintext part of the paging record or an encrypted part of the paging record;
or,
wherein the determining, by the terminal, content of the paging message based on the capability information of the terminal and/or the configuration information comprises any one of the following:
in a case that the configuration information comprises enabling the digital signature function for the paging message, determining, by the terminal, that a paging record in the paging message comprises a digital signature corresponding to a paging record of the terminal;
in a case that the configuration information comprises enabling the digital signature function for the paging message, determining, by the terminal, that the paging message comprises a digital signature corresponding to the paging message; or
in a case that the capability information of the terminal comprises supporting the digital signature capability for the paging message, determining, by the terminal, that the paging message comprises the digital signature corresponding to the paging message;
wherein the digital signature corresponding to the paging record of the terminal is determined based on the encrypted paging record; or
the digital signature corresponding to the paging message is determined based on the encrypted paging message.

9. A paging message processing method, comprising:
receiving, by a network-side device, capability information that is of a terminal and that is related to security protection of a paging message; and
sending, by the network-side device, configuration information to the terminal, wherein the configuration information is used to enable or disable security protection for the paging message.

10. The method according to claim 9, wherein the method further comprises:
receiving, by the network-side device, an acknowledgement message sent by the terminal in response to the configuration information.

11. The method according to claim 9, wherein the network-side device comprises a core network device, and the method further comprises:
sending, by the network-side device, the configuration information to a first base station and/or at least one second base station, wherein
the first base station comprises a serving base station of the terminal, and the at least one second base station comprises a base station to which a radio access network notification area (RNA) configuration or a tracking area (TA) configuration of the terminal belongs.

12. The method according to claim 11, wherein the sending, by the network-side device, the configuration information to a first base station and/or at least one second base station comprises:
when the network-side device successfully receives the acknowledgement message, or when the network-side device pages the terminal, sending, by the network-side device, the configuration information to the first base station and/or the at least one second base station;
or,
wherein the method further comprises:
when the network-side device fails to receive the acknowledgement message sent by the terminal in response to the configuration information, or when the network-side device pages the terminal, sending, by the network-side device, indication information to the first base station and/or the at least one second base station, wherein the indication information is used to indicate not to enable security protection for the paging message of the terminal.

13. The method according to claim 9, wherein the network-side device comprises a first base station, the first base station comprises a serving base station of the terminal, and the method further comprises:
sending, by the network-side device, the configuration information to at least one second base station, wherein the at least one second base station comprises a base station to which a radio access network notification area (RNA) configuration or a tracking area (TA) configuration of the terminal belongs;
wherein the sending, by the network-side device, the configuration information to at least one second base station comprises:
when the network-side device successfully receives the acknowledgement message sent by the terminal in response to the configuration information, or when the network-side device pages the terminal, sending, by the network-side device, the configuration information to the at least one second base station; or,
wherein the method further comprises:
when the network-side device fails to receive the acknowledgement message sent by the terminal in response to the configuration information, or when the network-side device pages the terminal, sending, by the network-side device, indication information to the at least one second base station, wherein the indication information is used to indicate not to enable security protection for the paging message of the terminal.

14. The method according to claim 9, wherein the network-side device is a first base station, the first base station comprises a serving base station of the terminal, and before the sending, by the network-side device, configuration information to the terminal, the method further comprises:
sending, by the network-side device, the capability information to a core network device; and
receiving, by the network-side device, the configuration information sent by the core network device.

15. The method according to claim 9, wherein the network-side device is a first base station, and the method further comprises:
determining, by the network-side device, whether to enable security protection for the paging message;
determining, by the network-side device, content of the paging message based on a case that security protection is enabled or disabled; and
sending, by the network-side device, the paging message.

16. The method according to claim 15, wherein the determining, by the network-side device, whether to enable security protection for the paging message comprises at least one of the following:
sequentially determining, by the network-side device based on a sending sequence of paging records in the paging message, whether to enable security protection for the paging message; or
determining, by the network-side device based on the configuration information, whether to enable security protection for the paging message;
or,
wherein the determining, by the network-side device, content of the paging message based on a case that security protection is enabled comprises:
determining, by the network-side device in a case that an encryption function is enabled, that a paging record in the paging message comprises at least one of the following:
a plaintext part of the paging record; or
an encrypted part of the paging record;
wherein the determining, by the network-side device based on a case that security protection is enabled, that a paging record in the paging message comprises an encrypted part of the paging record comprises at least one of the following:
receiving, by the network-side device, the encrypted part that is of the paging record and that is sent by a core network device; or
performing, by the network-side device, an encryption operation on the paging record to obtain the encrypted part of the paging record;
or,
wherein the determining, by the network-side device, content of the paging message based on a case that security protection is enabled comprises any one of the following:
in a case that a digital signature function is enabled, determining, by the network-side device, that a paging record in the paging message comprises a digital signature corresponding to a paging record of the terminal; or
in a case that the digital signature function is enabled, determining, by the network-side device, that the paging message comprises a digital signature corresponding to the paging message;
wherein the digital signature corresponding to the paging record of the terminal is determined based on the encrypted paging record.

17. A paging message processing method, comprising:
determining, by a third base station, that a paging record in a paging message comprises a digital signature corresponding to the paging message; and
sending, by the third base station, the paging message; or
determining, by a third base station, whether to enable security protection for a paging message;
determining, by the third base station, content of the paging message based on a case that security protection is enabled or disabled; and
sending, by the third base station, the paging message.

18. A communications device, comprising a processor and a memory, wherein the memory stores a program or instructions capable of running on the processor, and the program or instructions are executed by the processor to implement the steps of the method according to claim 1.

19. A communications device, comprising a processor and a memory, wherein the memory stores a program or instructions capable of running on the processor, and the program or instructions are executed by the processor to implement the steps of the method according to claim 9.

20. A communications device, comprising a processor and a memory, wherein the memory stores a program or instructions capable of running on the processor, and the program or instructions are executed by the processor to implement the steps of the method according to claim 17.
